(19) United States
(12) Patent Application Publication
(10) Pub. No.: US 2005/0177531 A1
(43) Pub. Date: Aug. 11, 2005

(54) Method, tool and system for increasing the efficiency of a design process

(76) Inventor: Robert H Bracewell, Cambridge (GB)

Correspondence Address: NIXON & VANDERHYE, PC, 901 NORTH GLEBE ROAD, 11TH FLOOR, ARLINGTON, VA, 22203, US

(21) Appl. No.: 10/507,002

(22) PCT Filed: Jun. 23, 2004
(86) PCT No.: PCT/GB04/02690

(30) Foreign Application Priority Data
Jun. 24, 2003 (GB) 0314641.2
Aug. 15, 2003 (GB) 0319170.7

(51) Int. Cl. G06N 5/00

(52) U.S. Cl. 706/45

(57) ABSTRACT

The invention relates to a method, tool and system for increasing the efficiency of a design process, particularly the capture and reuse of rationale behind design decisions. A tool having an interactive graph editor is used to capture a first design rationale of a first design project, the first design rationale containing data on at least one design issue and a processing means allows the first design rationale to be identified when the at least one design issue is encountered on a second design project. A computer and program are also described and these may be used as part of a system.

### BACKGROUND

This invention relates to a method, tool and system for increasing the efficiency of a design process. In particular this invention relates to improvements in the efficiency of the capture of the rationale behind design decisions. Such captured design rationale may subsequently be reused in future design decisions which may be associated with the same or different design projects or problems.

Designing complex systems or products, such as jet engines, involves many specialists working together as a large interdisciplinary team. Each design decision is influenced by many complex factors to achieve an optimal solution. For example, during development of a particular jet engine problems may be experienced which makes it impossible to routinely keep within required tolerances when assembling engine components once the components are removed from tooling jigs. This may be due to one of several issues or more, and is usually a combination of such issues.

Solving such problems usually involves a highly skilled team of experts looking at various possible issues and potential solutions. During this process many design issues are studied in depth, only some of which actually contribute to the final design solution. However, all the issues studied in some way, have contributed to a design rationale, and therefore could be important in solving future design problems in the same or different technical fields. However, in traditional design reports and other methods of capturing design rationale, the issues studied that did not effect the final design solution, are not usually fully documented. Similarly, rejected solutions to problems have also been discarded or not stored with a view to using the results again.

Tools and methods for capturing the design rationale and making such data readily available to personnel who may require it (even if they do not know of its existence), are becoming increasingly important in high technology industries as: design complexity grows, team sizes grow, and experts are redeployed on new projects or change employment. (Typically designers and engineers working on a particular design may not even be located in the same country, let alone building, and the storage and accessibility of data and redeployment of experts with the risk that they take their knowledge of design rationale with them) presents a real problem to companies wishing to manage their knowledge base.

Some ways in which companies or project leaders have attempted to manage the data generated were to:
Reduce the loss of knowledge through movement of engineers.
Extract more useful knowledge from large quantities of design experience.
Capture design rationale in a form that way easily re-usable by other projects, and businesses.

As a result of these and other reasons it was desirous to avoid repetition of past problems and errors and, as a general rule, create fewer new problems due to lack of understanding of design intent.

### PRIOR ART

Many attempts to record design rationale have been made. However, formal recording processes that do not aid, for example, a design team in efficiently reaching a design solution have been found to place an undue burden on the design team, in terms of additional effort in formulating the required records and time away from working on the design solution in question.

Informal recording processes tend to treat records as unstructured information, and accordingly it is not easy subsequent to the recording of information to access the rationale in response to a query. Also the informality of such an approach does not aid design teams in efficiently reaching a design solution for the current design problem.

U.S. Pat. No. 5,471,560 (Honeywell Inc) describes a method of acquiring and organising expert knowledge by way of a structured ‘node’ information network. A user is prompted to provide a response to a series of operations or statements and the subject matter of each response is stored and arranged in accordance with a logical set of relationship governing rules. One rule requires the user to define a current goal and to categorise the data according to said goal. The system, associated with the method stores data in accordance with rules specified by the user.

Although successful, the aforementioned types of method and system were relatively inflexible and complex designs, which did not readily lend themselves to classification and indexing, were not always able to be incorporated in a readily accessible format or stored. More importantly no opportunity was provided in the system disclosed in U.S. Pat. No. 5,471,560, to refer to design proposals, ideas or models that were unsuccessfully attempted. Often, although unsuccessful such design failures, and knowledge relating to the reasons for the failures, provide important records illustrating experience and reason for reaching particular conclusions or designs.

It is often necessary for the design rationale once captured to be accessible in a simple and effective way in any design issue to which it may be pertinent. It has been a problem with methods, tools and systems for capturing the rationale behind design decisions and the subsequent reuse of the rationale in future design decisions. It is very rare for a design issue to be exactly repeated at a future date. However, some issues that have arisen in other design rationales are very likely to be relevant in a subsequent design problem.

Design problems are usually ill defined and rely heavily on domain knowledge. This implies that what constitutes a problem is highly subjective. Therefore, because the design process depends on the problem, it inevitably depends on the designer or design team too. Furthermore, as mentioned above, design problems are considered to be complex. The degree of complexity of a problem may relate to, among other factors, the number of steps required to reach a solution or to the quantity of information required. More complex problems induce cognitive processes with a different qualitative character than those of less complex problems. Thus, in more complex problems the processes that monitor the overall problem solving process play more of an important role. This supports the requirement for a process-based approach to design, but also emphasises the need for flexibility in its application to adapt to the complexity of the problem. Furthermore, it underlines the importance of easy retrieval of knowledge (information) relevant to the problem/product.

A publication entitled: “A Process-based Approach to Computer Supported Engineering Design”, PhD Thesis, University of Twente, Enschede, the Netherlands, Black Bear Press Ltd., Cambridge 1994, proposed a PROcess-based SUpport System (PROSUS), that focuses on the interaction between the designer and computer system.

The proposed computer system for PROSUS focuses on support rather than automation, and on supporting the whole design process. This implies a close co-operation between user and system. Therefore, PROSUS considered it necessary to develop a model covering the tasks of designers and the computer system. Such a model, in covering the various tasks involved in design, enables shifts in the task distribution without the need for large modifications of the model. This allows stepwise system development and implementation, e.g. to adapt to developments in computer science, and it allows adaptation to tools available in a company for specific tasks.

A primarily problem-oriented, process-based model of design was used. The model of design at the core of PROSUS is the design matrix (PROSUS matrix), that acts as the knowledge structure for the computer system. The model constitutes generic knowledge of a system of a design process, i.e. possible steps; relationships between the steps (based on contents rather than on the sequence of execution); and possible means to support the steps. In working with PROSUS the designer(s) uses the structure given by the model to document data that evolves from or is generated in a project. In this way a designer provides the context to interpret an input. This also enables the system to learn e.g. new strategies or applications for specific means.

PROSUS matrices represent an attempt at combining and extending Issue Based Information System (IBIS), that provide a way of documenting design rationale on a microscale. One example was published by Kunz, W. and Rittel, H. W. J. entitled: “Issues as Elements of Information Systems”, Working Paper 131, Centre for Planning and Development Research, University of California, Berkeley, with Methodical Design, describes a prescriptive model of the design process, which in proposing stages and activities, also provides a general set of issues and a process-related structure for these issues. Another paper was published by Kroonenberg, H. H. v. d.: 1978, entitled: “Methodisch Ontwerpen”, in Faculteit der Werkuigbouwkunde, Diktaat Universiteit Twente, Enschede, the Netherlands.

PROSUS matrices provide designers with graphical working areas for capturing and indexing product data and design rationale during the design process. A matrix consists of three columns representing design activities, namely, generation, evaluation and selection; and rows representing generic classes of issues to be addressed. A distinction was often made between product, assembly and component matrices, each associated with a node of a product breakdown. A completed design has a single selected solution for every identified issue in every matrix.

In literature several PROSUS-like system implementations have been reported, Rodgers, P. A., Blessing, L. T. M., Caldwell, N. H. M., Huxor, A. P. 1999, “Exploring the Effectiveness of Network-based Tools in Distributed Conceptual Design Activity”, in The Continuum of Design Education, Juster, N. P. (ed.), pub. Professional Engineering Publishing Ltd., London, pp. 151-161; McMahon, E. H.: 2001, “Odyssey-Managing Design Information on the Web”, IDED01, Glasgow, UK. Besides these, many other systems for design rationale capture have been proposed, (e.g. gIBIS, Conklin, J. and Begeman, M. L.: 1988, “GIBIS: A hypertext tool for exploratory policy discussion”, ACM Transactions on Office Information Systems, (4), pp. 303-331, PHI, McCall, R. J.: 1991, “PHI: A Conceptual Foundation for Design Hypermedia”, Design Studies, Col. 12 (No. 1), pp. 30-41, Maclean, A., et al: 1991, “Questions, Options, and Criteria: Elements of Design Space Analysis”, Human Computer Interaction, Vol. 6, pp. 201-250, Compendium, Conklin, J., et al: 2001, “Facilitated Hypertext for Collective Sensemaking: 15 Years on from GIBIS”, Proceedings of the 12th ACM Conference on Hypertext and Hypermedia, Arhus, Denmark, and DRL, Lee, J. and Lai, K: 1991, “What's in a Design Rationale?”, Human Computer Interaction, Vol. 6, 1991, pp. 251-280. Albeit to different extents, all these systems have been influenced by the basic IBIS concept.

It is now widely acknowledged that rarely have systems of this type been successfully applied in industry. Similarly to IBIS-like systems, PROSUS matrices support the capture of alternative solutions for each issue. However, although an implementation of PROSUS could support automatic capture of the temporal sequence of proposed solutions and issues arising from them, their causal dependencies are not captured or represented. This can cause problems for the design team including confusion if it is difficult to identify and immediately select the best alternative, or if an original selection is later changed.

International Patent Application WO-A1-0221345 (University of Arizona) describes a knowledge acquisition system used in the design of complex mechanical equipment. The system enables a user to access one or more databases, in accordance with a series of rules, in order to generate a model of the piece of mechanical equipment. No record is kept of the design rationale; instead the system merely provides access to respective databases which are able to provide expertise about particular facets of the equipment to be designed.

An object of the present invention is to allow similarities and differences of two design contexts to be readily appreciated and to supply the relevant design rationale captured to a subsequent issue.

It is another object of the present invention to provide a method, tool and system to assist a design team in reaching a design solution efficiently, whilst capturing the rationale, including causal dependencies, behind design decisions.

Another object of the present invention to provide a method, tool and system to assist a design team to reach a design using decisions associated with one or more similar or different design projects.

### SUMMARY OF THE INVENTION

According to a first aspect of the present invention there is provided a design knowledge information capture tool comprising:
a storage means for storing the design knowledge information generated or acquired during progress of a first design project, wherein the design knowledge information extends beyond product design information and includes information on evolution of a first design project and causal dependencies;
an input means for allowing a user to input information into the storage means; and
a presentation means for presenting the design knowledge and product design information, wherein the input means includes a design stage or task classification means that is adapted to select a predefined file, with a list of at least one predefined issue to be addressed and presents a file template to the user to allow the information to be input by the user in a predefined knowledge structure, each piece of the information being input as a label of a node.

By providing designers with template graphs pre-seeded with issues appropriate to their design task or stage of a design process, design activities may beneficially be guided towards a more systematic approach. However, it is important to note that this step is not obligatory, as in other systems, therefore the present invention is more flexible.

For certain design tasks, such as diagnosis type tasks, the list of at least one predefined issue may be very broad, being purely, for example, one question “What are the causes?” Alternatively, a decision tree may be used to form said at least one predefined issue to aid the user in a systematic process to consider all potential causes of a problem. In other design tasks, such as evaluation of a design solution, the or each list, of at least one predefined issue, may be fixed and prescriptive, to ensure the effect of the solution on the overall design has been fully considered.

It is preferred that the storage means comprises an interactive editor. A graph editor ideally includes a label of the node, as well as the node itself, so that the information is stored in nodes of the graph editor. There may be different types of nodes to represent different types of information. The dependencies between the design rationale at each of the nodes may be represented by a directed link.

Advantages of this aspect of the invention are that users may tailor issues to be addressed; file templates and relationships between information that forms the knowledge structure, as the design knowledge information capture tool evolves.

The fact that the present invention has nodes allows a much simpler structure to be used to capture, store and retrieve information. This allows the tool to be more efficient and more flexible than previous systems, as well as allowing the information contained to be easily extracted for use on other design projects. The tool can readily be updated and adapted to a particular situation or context by users because unlike with previous systems, a user is not “boxed in” by the software.

Nodes may automatically be resized to display text of arbitrary width and number of lines. Particular types of node may be represented by a background shape or colour overlaid by text. This means that there is no longer a need to summarise the node into a short label. Also the whole contents of a node can readily be viewed at a glance without the need to resort to a different screen or viewer or open additional text boxes.

Sketches, images and other graphical elements may be readily and seamlessly embedded into the data structure. Links with dependencies may be pointed and anchored to a particular feature or location within graphical nodes of a graph editor. Therefore a link can be incorporated into a decision tree (showing for example design decisions) and graphs or images of specific data may be appended to the link so that they can be accessed directly whether for use as a support to a particular decision or chain of decisions or otherwise.

Such records of design rationale may be of significance in the event of an enquiry as to why a design choice was made, e.g. for review purposes, due diligence exercise or otherwise.

In a particularly preferred embodiment the tool may provide a structure of interlinked planar graphs into which complex information spaces may be organised. Reasons for, and dependencies between, decisions can therefore be unobtrusively captured. Additionally, by providing designers with template graphs, preceded with issues appropriate to the design task or stage of the design process, a guide can be provided as to the types of data and reasoning that can be input.

It is further preferred that the tool prompts the user to input at least one possible answer to the at least one predefined issue. At least one possible answer being stored as data at the label of a node. The structure may also prompt a user to input at least one argument that supports (or refutes) the possible answer, the at least one argument being stored as data at the label of the node.

It is further preferred that the structure prompts the user to input at least one argument that supports (or refutes) the possible answer, the at least one argument being stored as one of the, or each, piece of information at the labelled node.

The at least one argument may be classified as a supporting (or a refuting) argument. It may also be readily identified by the user as classified as the supporting or the refuting argument.

The at least one argument may also be classified as a valid or an invalid argument, after further consideration. It may also be readily identified by the user as classified as the valid or the invalid argument. An identifier of the status of an argument may also be included at the node or embodied in the form or type of node. The fact that the status of an argument is clearly represented, is another factor in making the tool user friendly and clear.

It is further preferred that the at least one answer is classified as an open, an accepted or rejected answer. The answer may also be readily identified by the user as classified as the open, the accepted or the rejected answer.

It is further preferred that the at least one predefined issue is supported by the at least one text statement. The at least one text statement may be readily identified by the user as believed true or known to be false.

Again, as for “answers” and “arguments”, their status may be included in the node to aid clarity. Status identifiers can also be included for “issues” and “sub-issues” and any node type required. The node may appear once only in a predefined file.

Each node only appears in a single predefined file, thus the user views the node only once and only in a single ‘view’ or computer screen display. This feature provides a clearly defined context, not present in state of the art knowledge capture tools where there is potential for the node to appear on multiple views. The clearly defined context helps make the invention more user friendly, whereas tools with multiple views have been found to deter users, as they were too complex.

It is particularly preferred that the, or each, piece of information stored at the label of the node, can be linked to a previously input file where the, or each, piece of information has previously been raised; or to an additional node on the predefined file wherein the, or each, piece of information has previously been raised. These links are hereinafter referred to as “tunnelling” links.

A sub-issue to the at least one predefined issue can be identified and input into the knowledge structure. The knowledge structure may prompt the user to input at least one possible answer to the sub-issue. The sub-issue may be linked by a “tunnelling link” to a previously input file or to an additional node.

It is particularly advantageous to utilise tunnelling links that appear to tunnel into the file template to reappear elsewhere, either on the file or a previously input file. A first end of the tunnelling link may be represented by a first icon and a second end of the tunnelling link may be represented by a second icon. The first and second icons may be designed such that, for example, double clicking with a mouse on the first icon causes the tunnelling link to be traversed to the second icon, and double clicking on the second icon causes the tunnelling link to be traversed to the first icon. A single character adjacent to the first and second icons may succinctly signify the type of piece of information linked via the tunnel.

Advantageously ends of the tunnel are anchored to a location within the node. This is particularly useful for linking features with graphics, sounds or other data suppressed by different software.

These features permit a large and complex rationale to be distributed across multiple two-dimensional representation clearly while still allowing easy navigation. Thus there is provided, in effect, a database of decision processes that led to a particular conclusion or design. A particularly attractive and useful feature of the database is the fact that both success and failure paths are documented and recorded.

The tool may have a processing means to identify at least one predefined issue addressed on a first design project is encountered on a second design project. Thus “tunnelling” links can be automatically created. The at least one predefined issue may derive from the sub-issue.

Different types of labelled nodes may be used for the different types of information i.e. issues, answers, arguments, text statements. They may have a small set of permissible current status values. The values may be portrayed by suitable combinations of changes in colour and/or geometry of, for example, the background shape and/or font style of the text. Values may be changed as work progresses from, for example, unresolved to resolved. The tool or system may allow a ‘job list’ of all unresolved or open nodes to be displayed or printed. Thus the tool provides clear prompts of what needs to be done, effectively combining the functions of a notebook and a ‘to do’ list. Additionally, dominant arguments can be emphasised clearly.

A complete set of linked files may also be directly printed providing a clear and comprehensive hard copy of a design rationale. No information is hidden in the tool that is not visible in the printout. Colours and shapes may be carefully chosen such that black and white printouts, while unavoidably not as clear as colour, are nonetheless unambiguous in meaning.

According to a second aspect of the invention there is provided a method for capturing design knowledge information wherein the information extends beyond product design information, said design knowledge information includes information on evolution of at least a first design and causal dependencies as to the reason for making a decision in the evolution of the design, comprising the steps of:
storing the information generated or acquired during progress of a first design in a storage means;
inputting information into the storage means; presenting the information to a user;
classifying a design stage and selecting a predefined file with a list of predefined issues to be addressed; and
presenting a file template for inputting the information into a predefined knowledge structure.

According to a third aspect of the invention there is provided a computer program executable to capture design information, wherein the design information is generated or acquired during progress of a first design project, the information extending beyond product design information and including information on evolution of the first design project and causal dependencies leading from one design to another, according to the method described above.

It will be understood that the computer may be accessed remotely, for example via a dedicated link, eg local area network (LAN) or wide area network (WAN), or it may be accessed via the Internet. When arranged in this way the invention may be used and updated by several teams, working on a large and complex problem, located in different regions or time zones.

According to a fourth aspect of the invention there is provided a computer programmed to capture design information, wherein the design information is generated or acquired during progress of a first design project, the information extending beyond product design information and including information on evolution of the first design project and causal dependencies leading from one design to another, according to the method above.

According to a fifth aspect of the invention there is provided a computer to capture design information, the design information being generated or acquired during progress of a first design project wherein the information extends beyond project design information includes information evolution of the first design project and causal dependencies including means for:
storing the information on a storage means; and
means for inputting the information into the storage means by first classifying a design stage and selecting a predefined file with a list of predefined issues to be addressed and presenting a file template to a user to allow the information to be input by the user in a predefined knowledge structure.

According to a sixth aspect of the invention there is provided a system operable to capture design knowledge/information, the design knowledge/information being generated or acquired during progress of a first design project wherein the information extends beyond project design information and includes information on evolution of the first design project and causal dependencies, according to the method described above.

According to a seventh aspect of the present invention there is provided a tool comprising a knowledge modelling tool having an interactive graph editor to capture a first design rationale of a first design project, the first design rationale containing data on at least one design issue and a processing means to allow the first design rationale to be identified when the at least one design issue is encountered on a second design project.

According to an eighth aspect of the invention there is provided a method for capturing and reusing a design rationale of a first project, the design rationale containing data on at least one design issue, including the steps of:
capturing the design rationale in a graphical format, and
processing the graphical format to allow the first design rationale to be identified when the at least one design issue is encountered on a second design project.

It is preferred that the method utilises an Issue-Based Information System. It is further preferred that the step of capturing the design rationale in graphical format incorporates the step of utilising nodes of the graph editor.

There may be a further step of representing different types of information by different types of the nodes.

According to a ninth aspect of the invention there is provided a computer programme executable to capture and reuse a design rationale of a first project, the design rationale containing data on at least one design issue according to the method described above.

According to a tenth aspect of the invention there is provided a computer design rationale containing data on at least one design issue according to the method described above.

According to an eleventh aspect of the invention there is provided a computer to capture and reuse a design rationale of a first project, the design rationale containing data on at least one design issue including means for: capturing the design rationale in a graphical format, and processing the graphical format to allow the first design rationale to be identified when the at least one design issue is encountered on a second design project.

According to a twelfth aspect of the invention there is provided a system operable to capture and reuse a design rationale of a first project, the design rationale containing data on at least one design issue according to the method described above.

When configured as a computer or database the system may include suitable encryption and decryption software in order to ensure security and integrity of data.

Embodiments of this invention will now be described, by way of examples only, and with reference to the drawings in which:

### BRIEF DESCRIPTION OF THE FIGURES

FIG. 1 is a matrix according to the prior art for documenting design rationale on a micro-scale by capturing and indexing product data and design rationale;

FIG. 2 shows a complete set of graphical representations used in one embodiment of this invention for design rationale modelling;

FIG. 3 shows a design rationale, applying the graphical representations shown in FIG. 2, to an aerospace application;

FIG. 3a shows a diagnosis stage of design;

FIG. 3b shows a solution stage of design;

FIG. 3c shows an evaluation stage of design;

FIG. 4 is a table of syntax statements, sybols and issues used in a preferred embodiment of a system

FIG. 5 shows a diagrammatical representation of a second embodiment of the invention;

FIG. 6 shows a graphical representation of the methodology used for designing and testing the present invention;

FIG. 7 shows graphically how the methodology of FIG. 6 was applied;

FIG. 8 shows a design rationale modelled using Graphlet (showing structure only);

FIG. 9 shows the complete set of graphical representations used in design rationale modelling; and

FIG. 10 shows an aerospace design rationale application for fire/fume assemblies, structured according to a design definition report (DDR).

### DETAILED DESCRIPTION OF PREFERRED EMBODIMENTS OF THE INVENTION

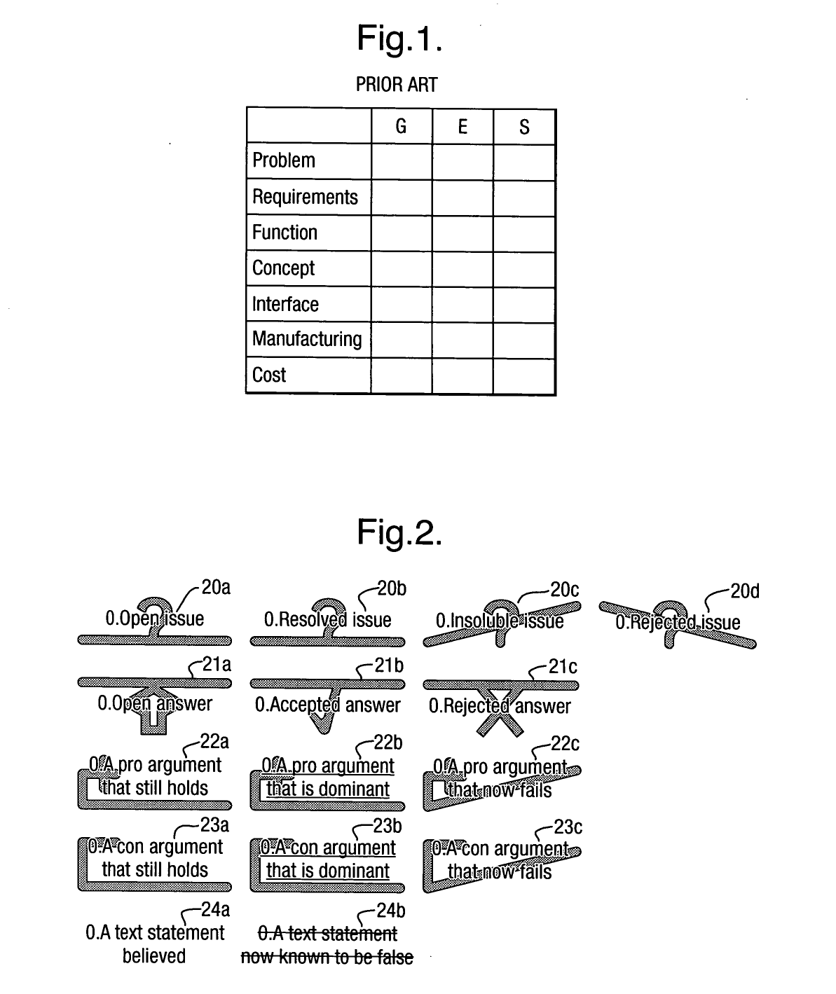

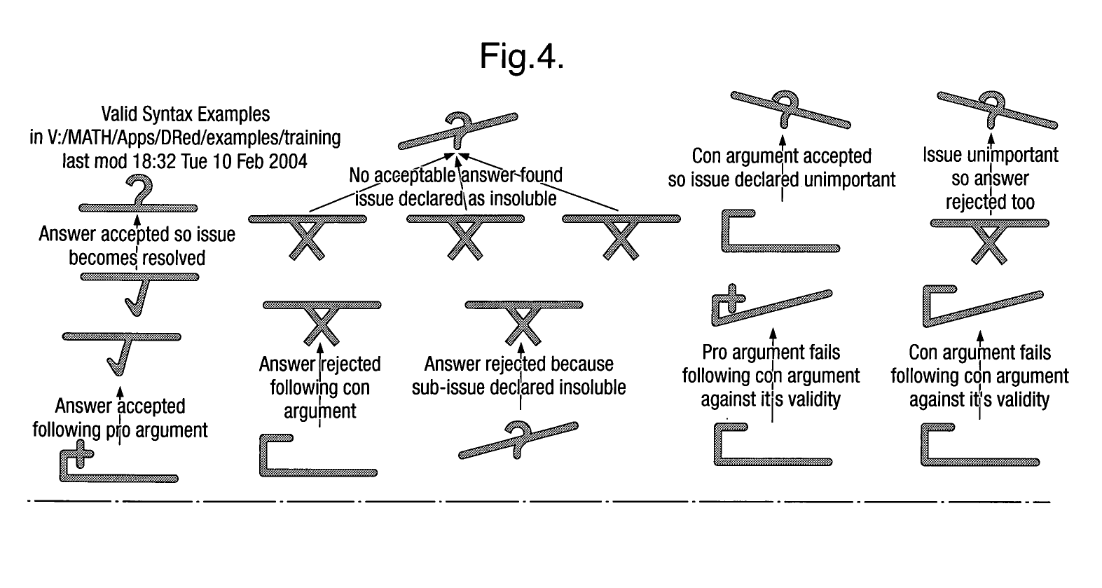

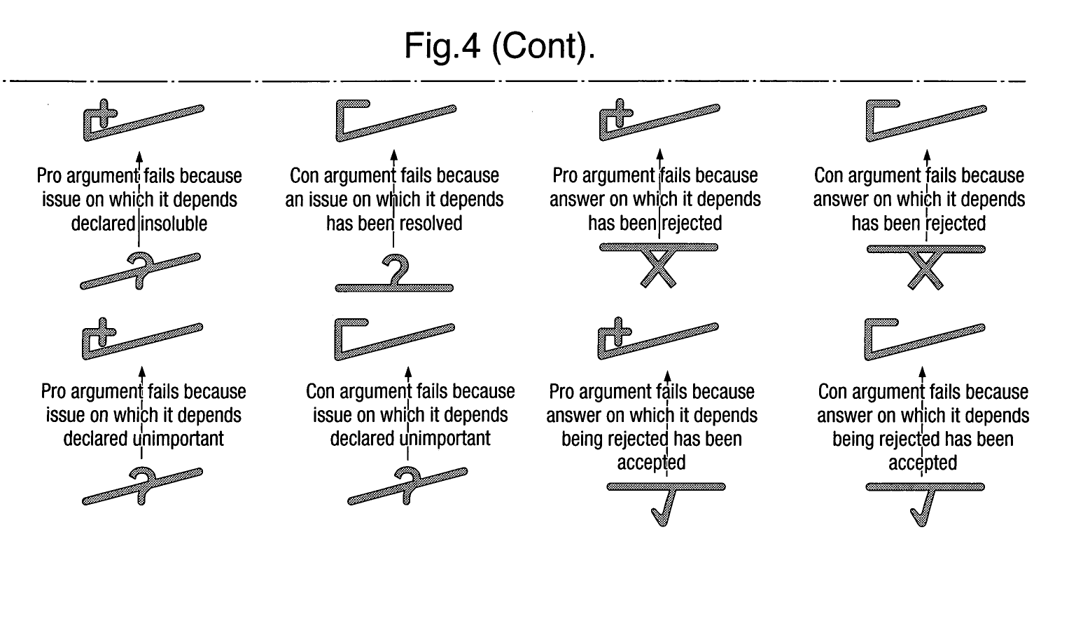

Referring to FIGS. 1 to 5 there is shown a first embodiment of the invention which is described with reference to a particular problem encountered during a design and diagnosis project. Although reference is made to several aspects of a jet engine, only diagrammatical references are depicted in the Figures.

Previously, as depicted for example in FIG. 1, design processes and procedures comprised a process of generating, evaluating and storing solutions in a matrix or linear format. A key problem associated with this type of design process was the fact that unless a clear and consistent indexing system was used, with nomenclature universally understood by current (and future) members of a design team, there were flaws in the system. Another drawback with such liner type systems was the inability to retrieve specific pathways leading to the conclusion of a particular design and the associated reasons for making that design.

The present invention is described with specific reference to a series of decisions (the design rationale) which were taken with a view to overcoming a real life problem—namely that of debonding of a part of an engine housing.

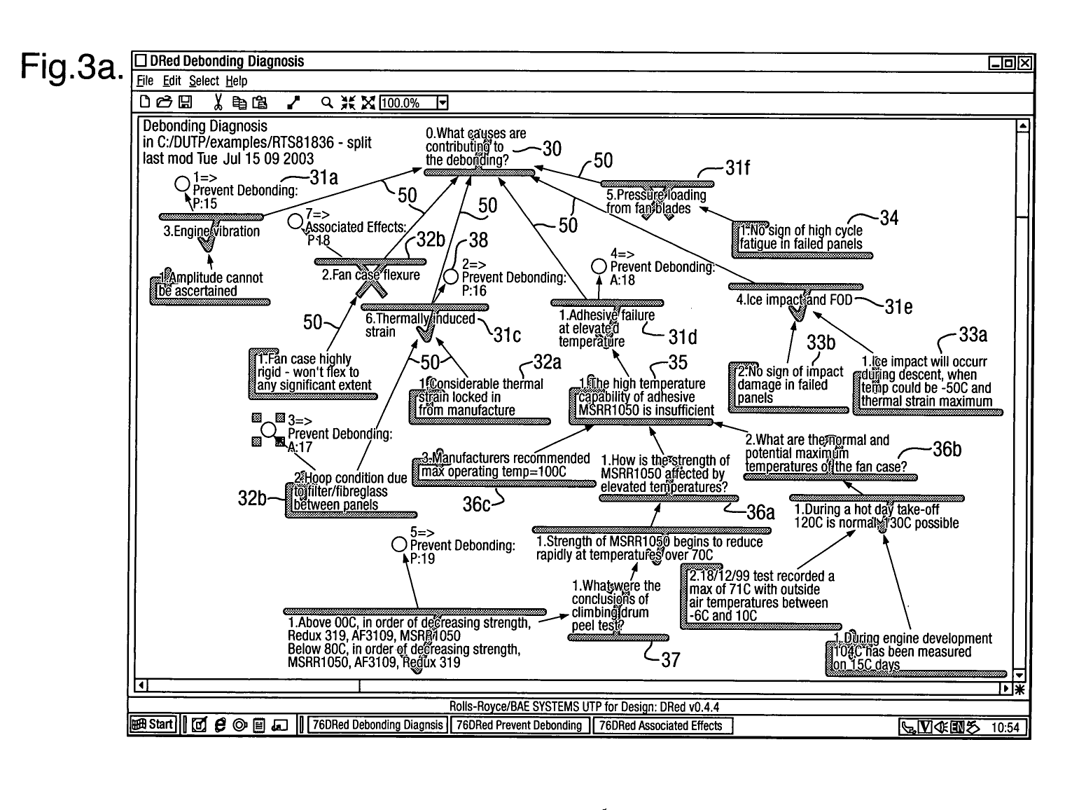

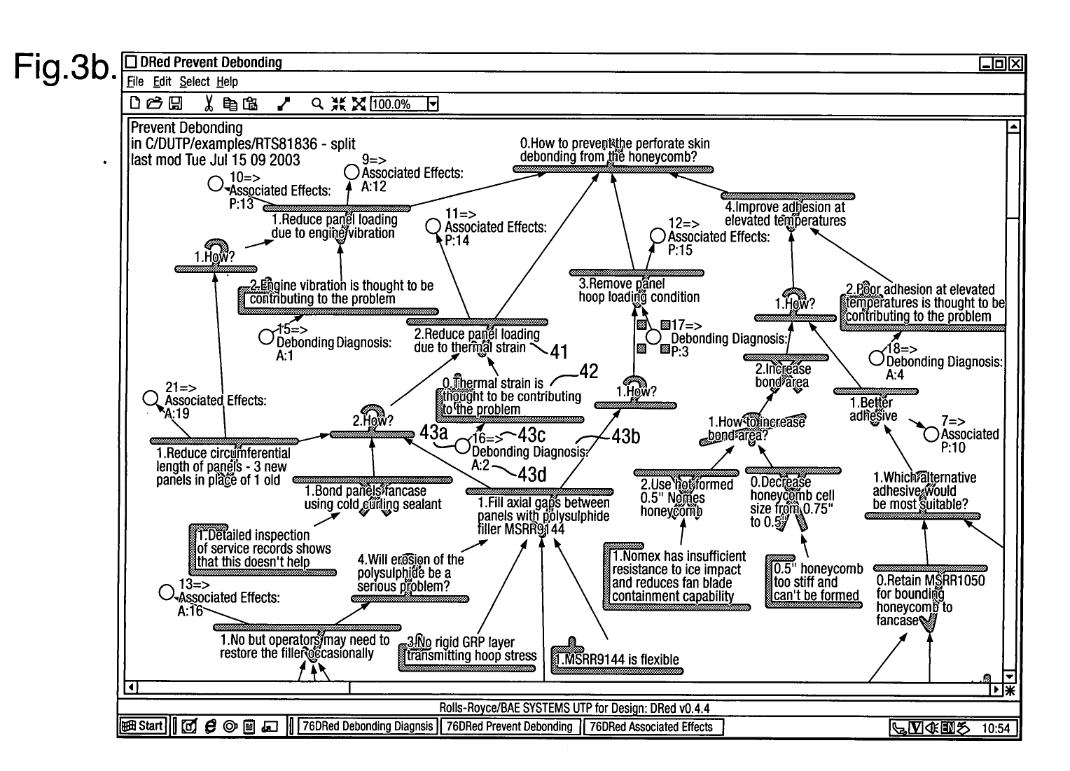

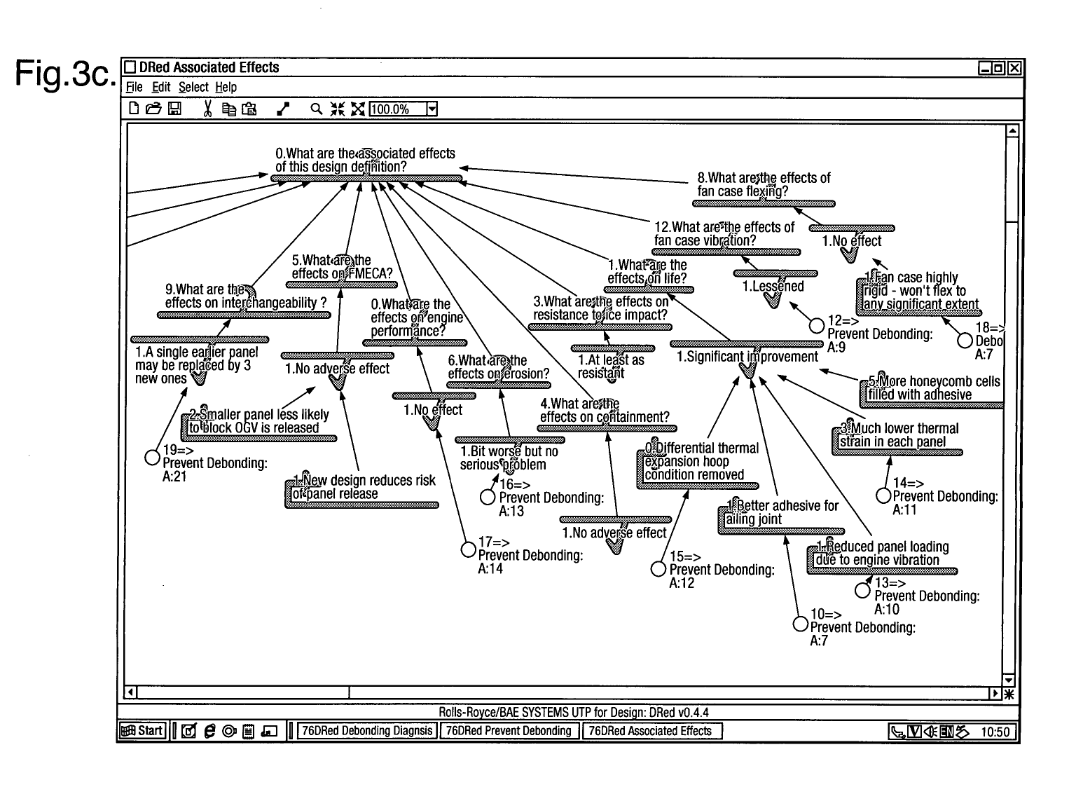

In the design application represented in FIG. 3, ice impact and acoustic panels of a jet engine fan case were manufactured from an aluminium honeycomb core, an aluminium perforate skin and a fibre glass edge frame. For ease of reference none of the items herein described are depicted but are referred to by way of example only. The honeycomb core is bonded to the perforate skin and edge frame using two plies of epoxy film adhesive. The edges of the honeycomb core are bonded to the sides of the edge frame using foaming epoxy adhesive.

Problems were encountered with the panel assembly in service where the perforate skin was detaching or debonding from the honeycomb core. The debond was exclusively within the so-called acoustic zone of the panels, from unfilled honeycomb cells only, and resulted in sections of the skin breaking away and being lost. Inspection of panels which suffered loss of perforate skin showed that the debond occured cleanly from the primed surface of the perforate skin, leaving the adhesive attached to the cell walls of the honeycomb core. The debond and loss of perforate skin caused a huge maintenance burden to airline companies.

A first design task to be tackled was to identify likely causes contributing to the debonding. A user (not shown) entered into the system an identifier to classify the design task as “Diagnosis”. This displayed a file template for use as “Diagnosis”. FIG. 3a shows one example of a completed Diagnosis File Template. The Diagnosis stage of any design process is the most flexible, due to the nature of the task, that is, to investigate a problem and find the likely causes.

In this case a predefined issues list may comprise simple statements such as “what are the causes?”. Alternatively they could be based on a decision tree that guides a designer (user) through a diagnosis process and acts as a check to ensure all relevant factors have been considered. Thus, in the Diagnosis Stage, a prime issue was identified as “What causes are contributing to debonding?” 30. As FIG. 3a shows the completed Diagnosis File Template the issue is identified as a Resolved Issue.

FIG. 2 shows symbols used to represent all issues and their status 20a-d. 20a shows an open (unresolved issue), 20b shows a resolved issue as seen in FIG. 3a, status 20c shows an issue that cannot be solved and 20d a rejected issue (a potential issue that turned out not to be an issue). All issue symbols are based on a question mark. As issues are the main questions, this is intuitive to the user. Colours can also be used to differentiate between the statuses of issues. Individual systems may be modified or customised for use by a particular user or group.

Thus in the example, six possible theories were suggested for further investigation. These were:
Engine Vibration, 31a
Fan Case Flexure, 31b
Thermally Induced Strain, 31c
Adhesive Failure at Elevated Temperature, 31d
Ice Impact and Foreign Object Damage (FOD), 31e
Pressure Loading from Fan Blades, 31f

These above six possible causes were classified as “Answers”. “Answers” are represented by the symbols shown in FIG. 2 as 21a-c.

Because FIG. 3a shows a completed template the status of all the answers is closed. Thus they are represented either as “Accepted Answers” 31a, 31c, 31d and 31e or after further investigation confirmed as not being a cause of debonding and are therefore classified as “Rejected Answers”, 31b and 31. FIG. 2 item 21a shows the symbol for an “Open Answer”, that is an “Answer” that requires further work to confirm or reject.

To confirm or reject “Answers” they are either supported or refuted by “Arguments”. In FIG. 2 the symbols for arguments, and their status, are shown as supporting arguments (pro arguments) 22a-c and refuting arguments (con arguments) 23a-c. Answer 31c—“Thermally Induced Strain”—was considered to arise from one or two arguments, namely: stored thermal strain locked in from manufacture, 32a and/or hoop condition due to filler/fibreglass between panels, 32b.

The symbol used for both arguments is that identified in FIG. 2 reference numeral 22b as a dominant supporting argument. A technical explanation for why these arguments are dominant supporting arguments is given below.

Considering the grounds for supporting argument 32a; in production a fan case assembly is heated to a temperature of around 175° C. when curing the bond between panels and the fan case. Aluminium has a higher rate of thermal expansion than steel and as a result perforate skins of the panel assemblies expand to a greater extent than the adjacent fan case during this cure cycle.

The bond between the panels and fan case is formed between 120° C. to 175° C. As the assembly cools, on completion of the cure cycle, thermal strain becomes locked into the panel assemblies as the perforate skins try to contract to a greater extent than the adjacent fan case.

Assuming the bond is formed at 175° C. the following differential thermal contractions between each perforate skin and the adjacent arc of fan case occur: at 15° C. (ISA day) A contraction=1.35 mm; and at temperatures of around −50° C. (the typical temperature during aircraft descent) Acontraction=1.7 mm. Thus thermal strain imposes a shear load onto the honeycomb core of the panel assemblies and onto the bonded joints at both sides of the honeycomb core. The resulting stress in the panel assemblies increases as the temperature of the fan case assembly reduces. Therefore thermal strain is considered to be a major contributor to debonding of the perforate skin. Thus considerable thermal strain locked in from manufacture and is considered a dominant supporting argument.

Secondly argument 32b was considered. Gaps between each panel in the fan case assembly were filled with blue filler MSRR1OOI which was covered with a fibreglass lay-up to prevent the filler being eroded by passing air flow from the fan (not shown). The combination of filler and fibreglass effectively connects each panel one to another. It was considered that this may cause a hoop condition to exist in the perforate skins, resulting from differential expansions of the skin and fan case, caused by changes in fan temperature that occur during a flight cycle. It was concluded that this may further compound the loading of the bond between the perforate skin and the honeycomb core and thus was considered a dominant supporting argument. Thus, the arguments 32a and 32b have supported the answer “Thermally Induced Strain” 31c and thus both are termed “Accepted Answers”.

Next “Ice Impact and foreign object damage (FOD)” 31e was considered. It can be seen that once again two arguments are associated with this potential answer. However, in this instance one is a Dominant Supporting Argument, “Ice impact can and does occur during descent, when the temperature could be −50° C. and thermal strain maximum”, 33a. The second answer was a refuting argument, namely: there is “No Sign of Impact Damage in Failed Panels”, 33b. From FIG. 2 the symbol used in argument (Answer 33b) can be seen to refute the argument that still holds 23a.

Technical explanations for 33a as a Dominant Supporting Argument and 33b as a Refuting Argument are given below. Consideration was given to whether impact by ice or foreign objects onto the perforate skin could be a primary cause of bond failure. No obvious signs of impact damage were reported on panels suffering from debond, and honeycomb that became exposed due to skin loss was generally reported as being in a good condition. It was therefore felt unlikely that impact of ice or foreign objects was the primary cause of repeated perforate debond. Thus argument “No Sign of Impact Damage in Failed Panels”, 33b holds but is not dominant.

It was also noted that ice impact will occur during descent, when fan case temperature may be as low as −50° C. and the panel assemblies are subjected to their highest loading caused by thermal strain (as discussed above). It was considered possible that ice impact may be contributing to the initiation and progression of the debond. Thus argument “Ice impact will occur during Descent, when temp could be −50° C. and Thermal Strain Maximum”, 33a was labelled as a Dominant Supporting Argument.

The Dominant Supporting Argument outweighs the Refuting Argument and thus Answer 31e is an Accepted Answer. “Pressure Loading from Fan Blades”, 31f is a Rejected Answer. It is refuted by one Argument, “No Sign of High Cycle Fatigue in failed Panels”, 34.

A technical explanation for the above reasoning is given below. The pressure wake from fan blades imposes a load onto perforate skin and cell walls of the honeycomb core. It was considered that the blade passing frequency may cause a high cycle fatigue of the honeycomb core and the bonded joint between the honeycomb core and the perforate skin. This was refuted by argument “No Sign of High Cycle Fatigue in failed Panels”, 34. Inspection of failed panels has shown no obvious sign of such fatigue in the honeycomb core or the adhesive. Thus loading from the fan blades was not considered to be a major contributor to the failure of the panels and the 31f is a Rejected Answer.

The answer “Adhesive Failure at Elevated Temperature”, 31d was supported by Dominant Supporting Argument “The High Temperature Capability of Adhesive MSRR1050 was insufficient”, 35. However, before this argument could be resolved it gave rise to further sub-issues, “How is the Strength of MSRR1050 affected by elevated temperatures?” 36a and “What are the normal and potential maximum temperature of the fan case?” 36b, as well as Supporting Dominant Answer “manufacturers recommended max operating Temperature=100° C.”, 36c.

Thus further issues arose and were treated in exactly the same way as the prime issue with the same predefined issue list being addressed by the user. Sub-issues may give rise to further sub-issues (see Reference numeral 37 that is a sub-sub-issue of sub-issue 36a).

Link arrows 50 link issues, answers, arguments and text statements (see below) that are part of the same design rationale. The direction of the link arrow 50 is, such that when the status of any issue, answer, argument or text statement is changed by the user, the arrows point to all issues, answers, arguments and text statements for which the status should consequently be reviewed.

The next part of the design process is to solve the problem or most liekly cause of the problem. When the causes of debonding are known, the next design task/stage is to solve the problem. That is: How to prevent the perforate skin debonding from the honeycomb?

Once again the user entered into the system an identifier. The design task was classified as “Solution” and accessed a file template entitled “Solution”. FIG. 3b shows an example of a completed solution file template. The Solution file template has a different predefined list of issues tailored to the solution stage of the design process. Once again Answers and Supporting and Refuting Arguments are input by the user. However, it is now possible for links to be formed between two template files. These, so-called “tunnelling” links, allow large problems to be handled, by allowing templates to be distributed, visualised and navigated across multiple files. Links appear to tunnel below the surface of a file or representation of a file (screen or window) and reappear elsewhere in the same or a different file. Links can then continue to their destination element. In browsing, the tunnel can be traversed for example, by double-clicking with a mouse pointer at a small circle 43a representing the tunnel opening, and the pointer is taken to a rote end of the tunnel.

Thus one of the answers in FIG. 3b is “Reduce panel loading due to thermal strain” 41 and is supported by dominant supporting argument “Thermal Strain is thought to be Contributing to the Problem”, 42. These are linked by a “tunnel” to the diagnosis template shown in FIG. 3a. A circle, 43a indicates the opening of the tunnel link. The text statement “Debonding Diagnosis” 43b indicates where the tunnel is linked to. “16 [symbol] >”, 43c indicates that it is tunnel opening 16. “A:2”, 43d indicates that the tunnel link is at an Answer tunnel opening 2 on the Debonding Diagnosis file. On FIG. 3a the other end/opening of the tunnel can be see at reference numeral 38.

Tunnelling links simplify the preparation and presentation of large rationale structures in a way that no other system provides. With tunnelling links a variety of information, in different formats, is available at a glance.

Tunnelling links provide dependency linking between views. They show clearly that a dependency on the status of an element of a particular type in a particular named view exists. Tunnelling links allow easy navigation through the tunnel to the view in which that element was defined and its context, meaning and status is clear. They also allow easy navigation back again through the tunnel.

FIG. 3c shows an evaluation stage. In this stage the predefined issue list is very rigorous to ensure the proposed design solution does not have detrimental effects on other design elements, or if it does these are well understood. Text Statements are used to identify tunnel links can be used for many reasons as identified by symbols 24a and 24b in FIG. 2.

It will be understood that many formats of graphical representations may be used in the invention. However, the representations used in this embodiment have found to be readily received by users and are very intuitive.

It will also be understood that the method could be used in many design applications and processes.

It has been found during evaluation with teams of aerospace designers that the system is very easy and intuitive to use, making for example, designers willing to capture rationale as it is developed, rather than at the end of a project. This makes the design process overall faster; more consistent and more rigorous. The view of the rationale structure is comprehensive and clearer to see and understand, (both by users and others), than say design notebooks or a software tool. Because the design tool is automated it can be accessed by teams in different locations, for example by way of encrypted links vis the internet. Use of the system tool therefore improves the design process and captures rationale as a valuable bi-product for use by subsequent design teams.

A particular advantage is the natural and intuitive interface, resulting in the system being easy to learn, easy to use and clear as an archival method.

The method of displaying element type and status using resizable coloured background shapes overlaid by text, saves screen area, allows more of the linked nodes (which provide the context of a particular node of interest), and enable the screen to be viewed at a glance. The fact that use of the invention makes complex processes and design decisions easy to grasp and the type and status of a particular statement, in a complex rationale, easy to understand has been due to its simplicity.

A printed output of a set of partially or fully completed templates is comprehensive in its information content and provides a hardcopy, closely matching what could be seen on screen using the tool. This makes it particularly clear and allows easy interpretation of the rationale structure.

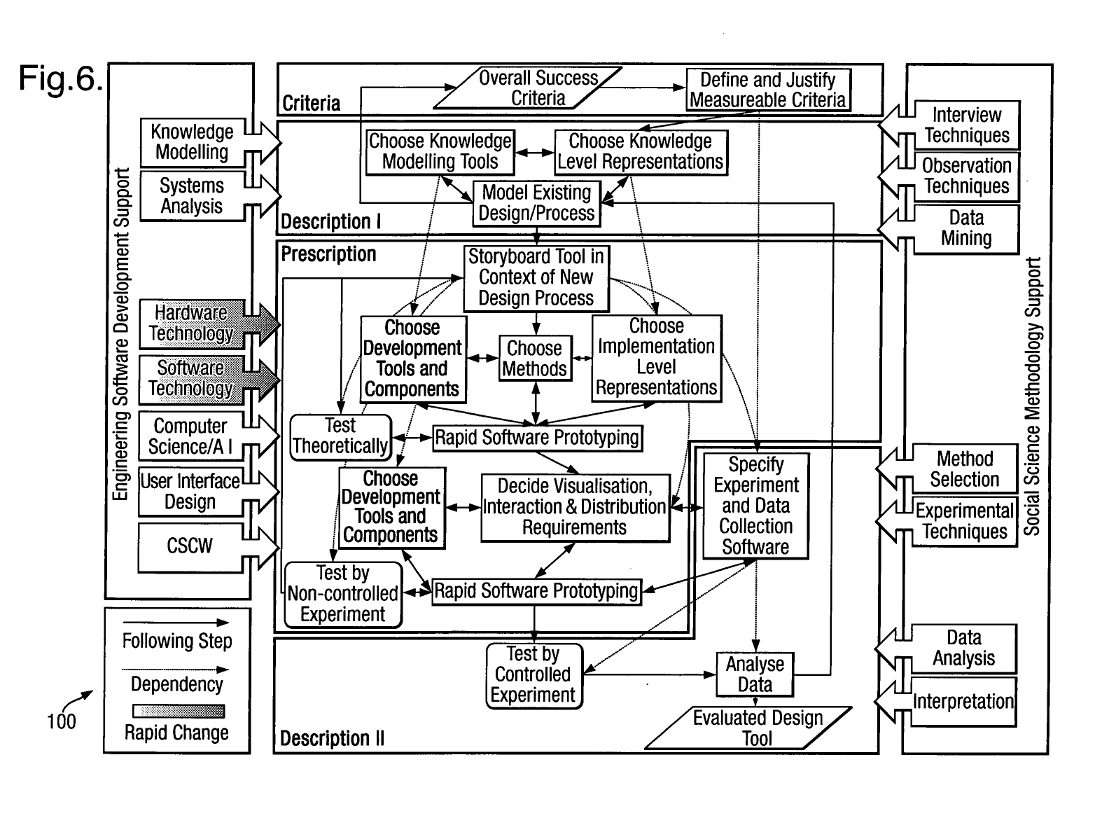

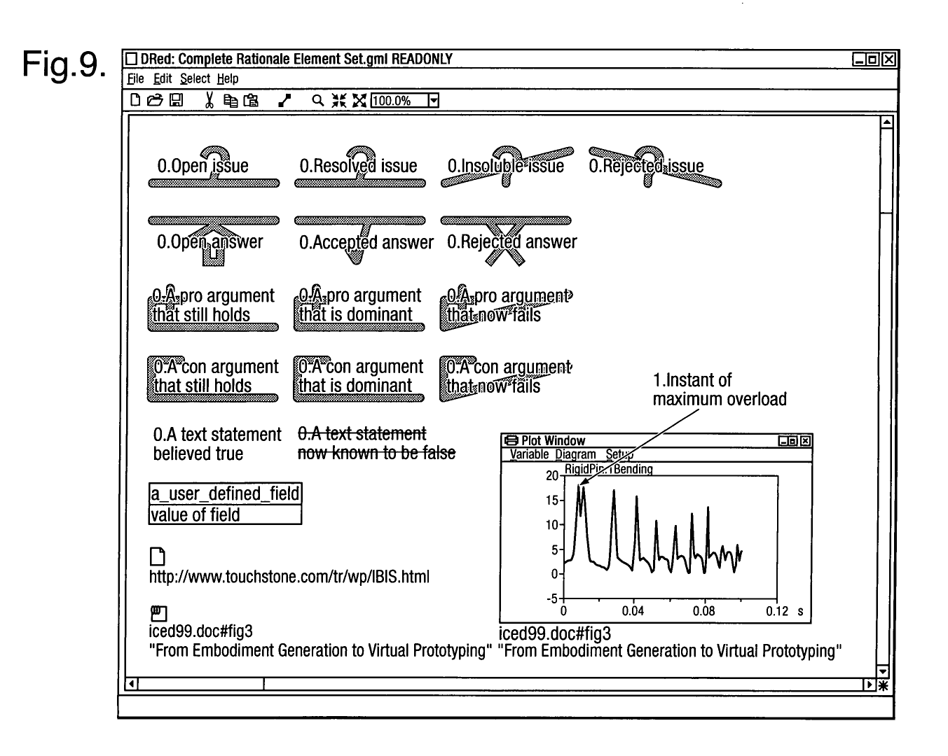

Referring now to FIGS. 6 to 10, which illustrate a second embodiment of the invention, FIG. 6 shows a graphical representation of methodology used for designing and testing the present invention. The methodology hereindescribed is a practical approach, intended to enable development of usable software prototypes as early as possible in research. The methodology provides a choice of high level languages, tools, reusable software components, integration and code-hardening mechanisms.

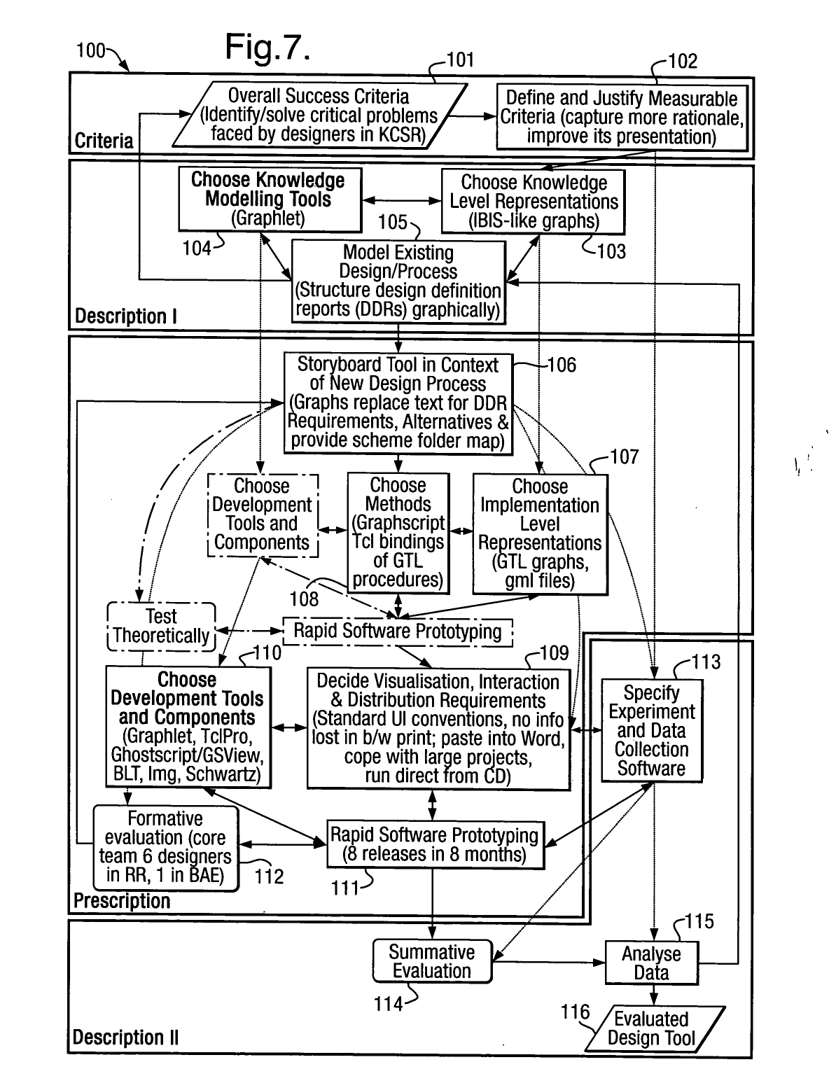

FIG. 7 shows how the methodology was applied to the design and testing of the present invention, and the tasks are numbered in the order that they were performed. Task 101 is “Overall Success Criteria” and states the basis for judgement of success or failure of the project under which the invention was created. The criteria were:

“Did the project correctly identify crucial problems faced by aerospace industry designers, in the capture, sharing and reuse of knowledge?” and “Did the project suggest how one or more of these problems could be solved?”

In task 2 “Define and Justify Measurable Criteria”, for the identified problem of the difficulty of recording Design Rationale (DR), it was considered that the merits of a technical solution might be established experimentally, by finding a larger quantity of DR to be captured per designer hour than standard practice (i.e. more efficiently), and whether the DR so presented is easier to understand.

The Description 100 stage models existing design processes, using well defined knowledge structures, to inform a proposal as to how that process could be measurably improved. An existing standard practice in the aerospace industry for DR capture is the preparation of a textual Design Definition Report (DDR), and the compilation of a loosely-structured paper Design Scheme Folder (DSF) at the end of a project. Despite the perceived poor usability of IBIS-like approaches, a preliminary examination of the contents of DDRs suggested that IBIS should be suitable. Hence for task “103 Choose Knowledge Level Representations” a provisional choice was made of IBIS-like graphs. The next step 104 was “Choose Knowledge Modelling Tools”, with the aim of finding a convenient and flexible tool to allow the representation to be tested and iteratively refined by instantiating it with DR from real cases.

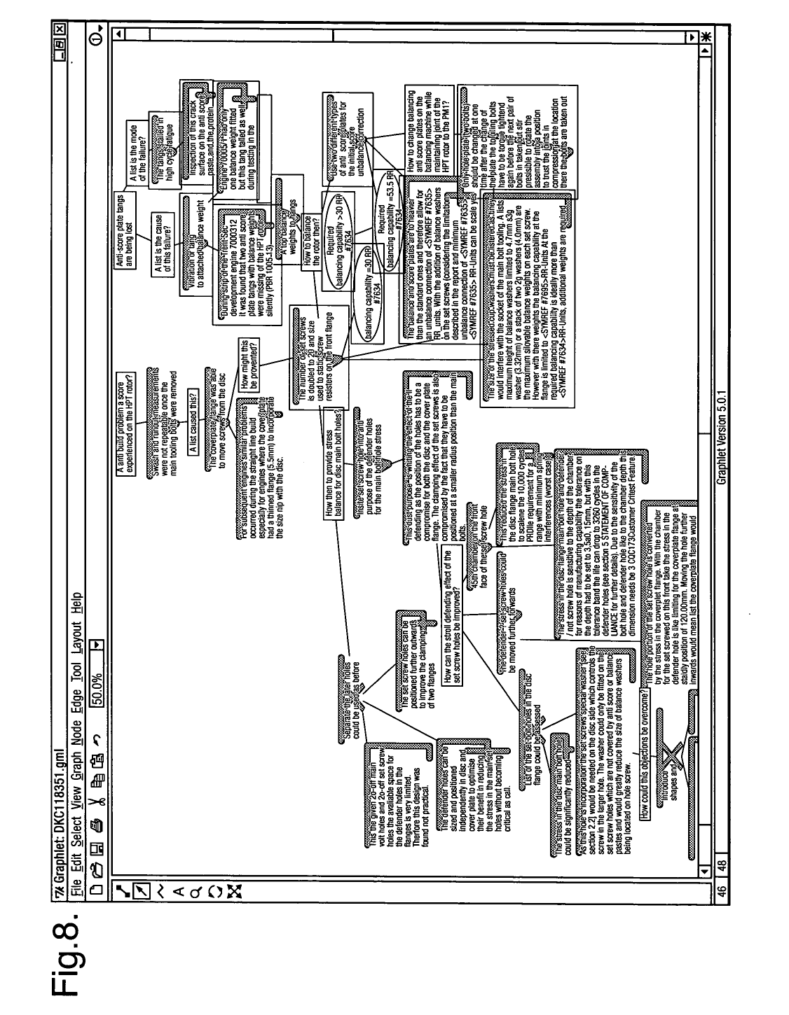

The knowledge modelling tool chosen was Graphlet, a general purpose interactive graph editor, free for non-commercial use, from the University of Passau. Graphlet employs the “two language” philosophy in which a robust and efficient compiled core underlies a configurable user interface written in a very high-level interpreted language. Graphlet was thus used in task 105 “Model Existing Design/Process” to explore the use of IBIS-like representations to structure graphically the DR contained in existing DDRs. A typical result of this work is shown in FIG. 8.

These DR graphs were felt by members of the project team to be easier and quicker to understand than textual reports from which they had been derived. Unlike the labelled icon node representations of Questmap, (Trade Mark) the issues, answers, pro and con nodes resized to contain multiple lines of text, behind which coloured graphics clearly signified the node type. The advantages, were that eliminating icons saved screen area, there was no need to summarise into labels, and nothing was hidden so a printed hard copy was readily available. The conviction grew that this approach was promising, and that the frequently reported problems with IBIS were surmountable if careful attention was paid to usability. The use of DR from real projects in this study convincingly demonstrated the feasibility and possible benefits of such a design support tool, attracting great interest in two aerospace companies.

The knowledge modelling exercise had suggested what sort of tool might answer the identified DR capture needs, but Graphlet was not an optimum choice. However, it had been chosen with forethought about the possibility of its use in the prescription stage. This was prompted by consideration of dotted dependency arrows in FIG. 8, from 104 “Choose Knowledge Modelling Tools” to step 110 “Choose Development Tools and Components” and from step 103 “Choose Knowledge Level Representations” to step 107 “Choose Implementation Level Representations”. These show that there may be an opportunity to jump-start tool implementation, if chosen knowledge modelling tool can also support rapid software prototyping, and precisely defined, robust, implementation level representations as well as the less formal knowledge level.

If a research prototype software tool is to be tested on live projects, it is imperative to consider practical details of its introduction. This is the first task of the Prescription stage 106 “Storyboard Tool in Context of New Design Process”.

In the present case, an initial Storyboard, was provided for designers simply to use the tool to create DR graphs that could either be directly printed and stored in the DSF, or imported into DDR Word documents.

In some Computer Aided Engineering Design (CaeD) tool research projects, underlying methods and representations are implemented first and tested by researcher(s) before adding a proper user interface to allow third party use. The methodology of FIG. 6 shows this by two levels of rapid software prototyping in the Prescription stage. In this case, by taking the approach of progressively modifying Graphlet using Tcl/Tk scripting, it was possible to combine these levels and have a proper user interface from the outset. Hence the upper level in FIG. 6 is greyed out.

Graphlet is built upon an underlying C++ Graph Template Library (GTL), that allows graphs to be represented, navigated, modified, loaded from and saved to, graph mark-up language (gml) files. Experience manipulating large graphs in the Description I stage, had shown these facilities to be both efficient and robust. Moreover, the GTL representation is extensible, in which attributes for any node or arc can be defined “on the fly”, and are saved to file. Hence Graphiet's GTL was chosen for step 107 “Choose Implementation Level Representations”, and Graphscript, its Tcl binding of the GTL procedures, was suitable for step 108 “Choose Methods”.

The next task 109 was termed “Decide Visualisation, Interaction & Distribution Requirements”. In terms of visualisation and interaction, it was considered vital that the tool should be as intuitive as possible to anyone familiar with Windows (Trade Mark) diagramming software such as MS Draw (Trade Mark) or Visio (Trade Mark). Fortunately, Graphlet's user interface already follows this principle reasonably well. It was further decided that though colour might be used to make the DR clearer on screen, although the meaning should be unambiguous if the graphs are printed in monochrome. Referring to a storyboard, it was decided that a way would have to be found to import Graphlet's Postscript output into MS Word (Trade Mark).

Step 110 “Choose Development Tools and Components”. Graphlet was run as a Tcl script and DLL from within the TclPro development environment, chosen mainly for its excellent debugging capabilities. Source Navigator IDE was chosen to aid the navigation, understanding and editing of Graphlet's large body of Tcl source code. Ghostscript (Trade Mark) and GSView (Trade Mark) were also chosen, as together they provide a command line utility called pstoedit, to convert Graphlet's Postscript output into Windows metafiles that can be imported into Word documents.

A common bottleneck in CaeD tool research lies in task 111 “Rapid Software Prototyping”. This is can be a time consuming and difficult problem for researchers to convert partially worked out research ideas into a sufficiently precise specification for satisfactory implementation by a programmer. The only way to avoid this problem completely, is for the researcher to code software personally.

By writing Tcl scripts to modify incrementally the Graphlet user interface, an initial prototype DR capture tool, that was named DRed v0.1 was produced. While limited, this was sufficiently functional to support real design work. Moreover, due to its solid foundations in the unmodified GTL library, and the run-time error checking of the modified and newly written Tcl scripts, it was immediately robust enough for designers to use with confidence.

As the basis for task 112 “Formative evaluation”, a core team of six aerospace designers was recruited to use the invention in their daily work. Immediate reactions were very positive, and accompanied by many helpful ideas about functionality and usability. There were also suggestions that its use in recording the design process was proving beneficial in lending structure to designers' thoughts. An efficient and productive research cycle of idea generation, implementation and testing ensued. Seven further releases of steadily increasing capability, and refinement of the underlying concepts, followed.

Various changes were made to the representations used. New element types were added, along with the idea that all elements, not just answers, should have a set of clearly indicated statuses. The current complete set is shown in FIG. 6. The initial arbitrary choice of link arrow direction was reversed, such that when the status of any node is changed by the designer, the arrows point from that node to all others for which the status should consequently be reviewed. A desire to use DRed to capture conceptual design of thermodynamic cycles for a new range of small jet engines, led to the concept of “tunnelling links” being devised.

In the course of the iterative research and implementation process, there was also a highly beneficial change of distribution strategy 109. It was realised it that DRed can easily be made to run directly from a CD-ROM or networked home directory. This enabled a major expansion of the storyboard for use of the tool 106. The DRed graphs could now be used to provide a map of the computer files generated during the design, and stored in an electronic DSF. The choice of three new software components 110, the BLT, lmg and Schwartz libraries for Tcl, solved the problem of allowing file reference nodes to be represented, if desired, by a bitmap graphic rather than the default icon (see the bottom right element in FIG. 7). This provided another major functionality enhancement requested by designers, as it meant that the output of any PC software, such as Computer Aided Design (CAD) or a spreadsheet, could easily be captured from screen and included in the DR graphs. Similarly design sketches, whether drawn directly onto a Tablet PC or scanned from paper, could easily be intermingled with textual rationale, combining the flexibility of a design notebook with a rigorous structure for arguments and dependencies.

Once the main functionality of DRed had stabilised, the research moved on to the more formal, summative evaluation of the Description II stage. This determined whether or not the use of the tool has had a positive impact on the measurable success criteria identified in task 102. In task 113 “Specify Experiment and Data Collection Software”, there is a trade-off between formality, and reality, of the experiment chosen.

Task 114 “Summative evaluation” was initiated by giving a two hour hands-on training course in small groups to around twenty new users. The evaluation has, at the time of writing, been ongoing and informal feedback continues to be highly positive.

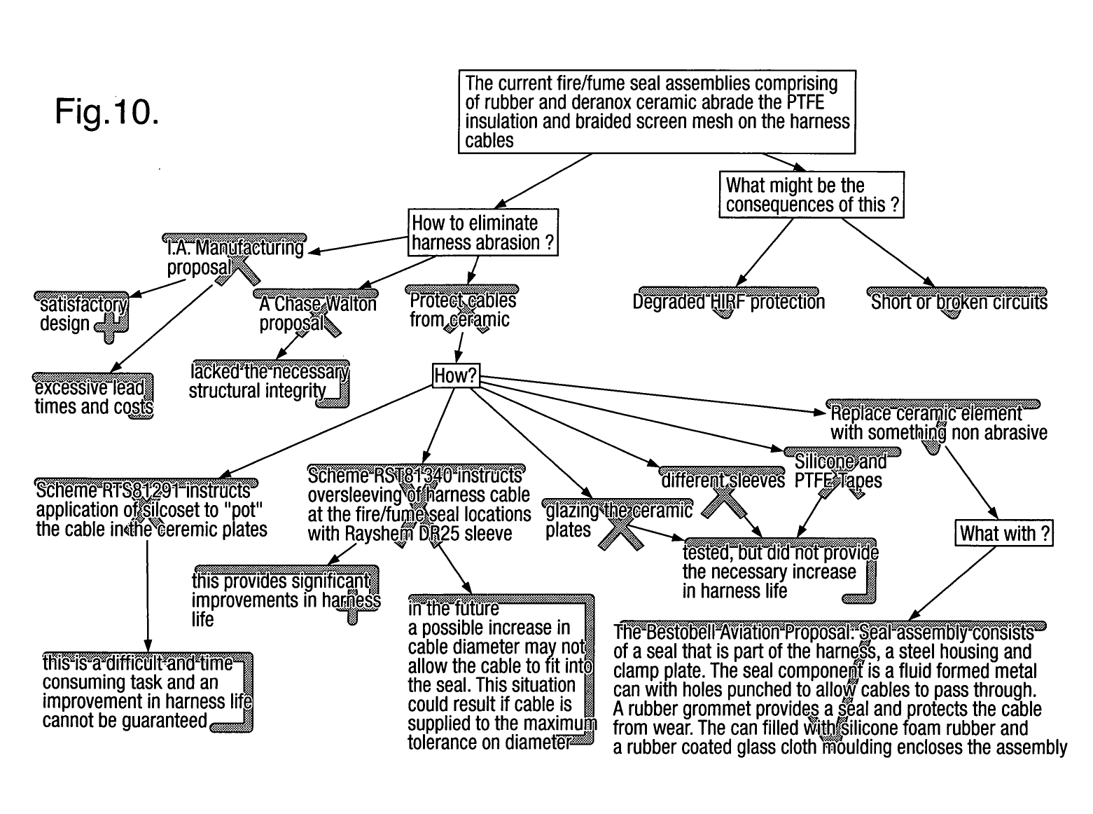

FIG. 10 shows an aerospace design rationale application for fire/fume assemblies, structured according to a DDR.

It will be appreciated that the printed output of a set of rationale canvasses is comprehensive in its information content and provides hardcopy closely matches what may be seen on screen using the tool. This makes it particularly clear and allows easy interpretation of the rationale structure.

The invention may also be incorporated in an indexing knowledge system such as a database arrangement for use with data items having one or more index terms associated therewith, comprising: relationship storage means operable to store relationship information relating to the index terms associated with the data items in the database; identifying means operable to identify the or each index term contained in a user request for interrogating the database; consulting means operable to consult the relationship information to identify other index terms which are associated with data items with which the index term or terms of the request are associated; and information means operable to provide information relating to the index terms or terms of the request and the other index terms, for presentation to the user.

The invention may also be incorporated in an indexing knowledge system such as a database arrangement for use with data items having one or more index terms associated therewith, comprising: relationship storage means operable to store relationship information relating to the index terms associated with the data items in the database; identifying means operable to identify the or each index term contained in a user request for interrogating the database; consulting means operable to consult the relationship information to identify other index terms which are associated with data items with which the index term or terms of the request are associated; and information means operable to provide information relating to the index terms or terms of the request and the other index terms, for presentation to the user.

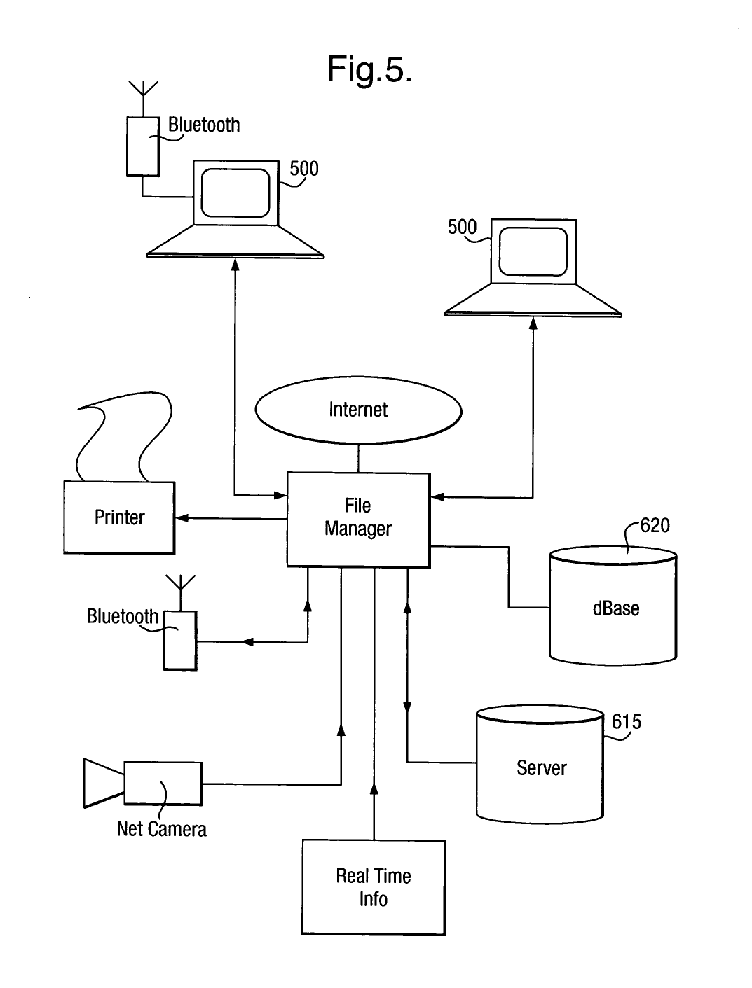

FIG. 5 shows a diagrammatical representation of a second embodiment of the invention in which there is a system having one or more input/output means 500 and which is operating under control of software as described above. The input/output means 500 may be personal computers (PCs), laptops or dedicated CAed/CAD terminals or stations.

Input/output means 500 are linked to a central file manager, which in turn provides access to a file server 615 and database 620. The system is depicted as being configured as a network so that input/output terminals are connected, for example by way of a local area network (LAN) or a wide area network (WAN) to enable remotely spaced designers and engineers to collaborate on the same or different projects simultaneously. Links may include suitable encryption devices or software so as to ensure security of data as it passes, for example, over wireless networks or the Internet.

Other input ports may include, for example, wireless free connections, an Internet gateway, a real time information source, for example from an item under test (not shown); and/or a camera, showing a particular piece of video footage. All data, as has been described above, is collected and stored in accordance with the operations and commands in the computer program, as design decisions are made. Data is then stored, so that it can be accessed subsequently.

One or more printers are shown in the network in order to enable users to print hard copies of records directly, under control of the file manager, from the database and/or a local server 615.

The invention may be described by way of exemplary examples only and it will be appreciated that variation may be made to the examples without departing from the scope of the invention.

1. A design knowledge information capture tool comprising:
a storage means for storing design knowledge information generated or acquired during progress of a first design project, wherein the design knowledge information extends beyond product design information and includes information on evolution of a first design project and causal dependencies; an input means for allowing a user to input information into the storage means; and a presentation means for presenting the design knowledge and product design information, wherein the input means includes a design stage or task classification means that is adapted to select a predefined file, with a list of at least one predefined issue to be addressed and presents a file template to the user to allow the information to be input by the user in a predefined knowledge structure, each piece of the information being input as a label of a node.

2. A tool according to claim 1 wherein the storage means comprises an interactive graph editor.

3. A tool according to claim 2 wherein the graph editor comprises the label of the node and the node.

4. A tool as claimed in claim 1 wherein, in use, a user is prompted by the knowledge structure, to input at least one possible answer to the at least one predefined issue, the at least one possible answer being stored as one of the, or each, piece of information at the label of the node.

5. A tool as claimed in claim 4 wherein the knowledge structure prompts the user to input at least one argument that supports or refutes the possible answer, the at least one argument being stored as one of the, or each, piece of information at the label of the node.

6. A tool as claimed in claim 5 wherein the at least one argument is classified as a supporting or a refuting argument.

7. A tool as claimed in claim 6 wherein the at least one argument can be readily identified by the user as classified as the supporting or the refuting argument.

8. A tool as claimed in claim 5 wherein said at least one argument is classified as a valid or an invalid argument.

9. A tool as claimed in claim 8 wherein the at least one argument is readily identified by the user and classified as the valid or the invalid argument.

10. A tool as claimed in claim 4 wherein the at least one answer is classified as an open, an accepted or rejected answer.

11. A tool as claimed in claim 10 wherein the at least one answer is readily identified by the user as classified as the open, the accepted or the rejected answer.

12. A tool as claimed in claim 1 wherein the, or each, piece of information stored at the labelled node is supported by at least one text statement.

13. A tool as claimed in claim 12 wherein the at least one predefined issue is supported by the at least one text statement.

14. A tool as claimed in either claim 12 or 13 wherein the at least one text statement can be readily identified by the user as believed true or false.

15. A tool as claimed in claim 1 wherein the node appears once only in the predefined file.

16. A tool as claimed in claim 1 wherein the, or each, piece of information stored at the label of the node can be linked to a node on a previously input file where the, or each, piece of information has previously been raised.

17. A tool as claimed in claim 1 wherein the, or each, piece of information stored at the label of the node can be linked to an additional node on the predefined file, wherein the, or each, piece of information has previously been raised.

18. A tool as claimed in any preceding claim wherein a sub-issue to the at least one predefined issue can be identified and input into the storage means.

19. A tool as claimed in claim 18 wherein a user is prompted to input at least one possible answer to the sub-issue.

20. A tool as claimed in claim 18, wherein the sub-issue can be linked to a previously input file.

21. A tool as claimed in claim 18, wherein the sub-issue can be linked to the additional node.

22. A tool according to any preceding claim having a processing means to identify at least one predefined issue addressed on a first design project, which issue is encountered on a subsequent design project.

23. A tool according to claim 22 wherein the at least one predefined issue derives from the sub-issue.

24. A knowledge modelling tool having an interactive graph editor to capture a first design rationale of a first design project; the first design rationale containing data on at least one design issue; and a processing means to allow the first design rationale to be identified when the at least one design issue is encountered on a subsequent design project.

25. A tool according to claim 24 comprising an issue-based information system.

26. A tool according to claim 24 wherein the design rationale is captured in nodes of the graph editor.

27. A tool according to claim 26 wherein the nodes are part of a two-dimensional representation of the design rationale.

28. A tool according to claim 24 wherein dependencies between the design rationale at each of the nodes is represented by a directed link.

29. A tool according to claim 24 wherein tunnelling links that appear to tunnel into the first two-dimensional representation reappear elsewhere, either on the first two-dimensional representation or a second two-dimensional representation.

30. A tool according to claim 29 wherein a first end of the tunnelling link is represented by a first icon and a second end of the tunnelling links is represented by a second icon.

31. A tool according to claim 30 wherein the first and second icons are designed such that double clicking on the first icon causes the tunnelling link to be traversed to the second icon, and double clicking on the second icon causes the tunnelling link to be traversed to the first icon.

32. A tool comprising a knowledge modelling tool according to claim 24 having an interactive graph editor which enables a user to modify features of an output in order that the features can be differentiated more clearly one from another.

33. A method for capturing design knowledge information wherein the information extends beyond product design information and includes information on evolution of the first design project and causal dependencies, comprising the steps of: storing the information generated or acquired during progress of a first design project in a storage means; inputting information into the storage means; presenting the information, during the step of inputting the information; classifying a design stage and selecting a predefined file with a list of predefined issues to be addressed; and presenting a file template for inputting the information into a predefined knowledge structure.

34. A method for capturing and reusing a design rationale of a first project, the design rationale containing data on at least one design issue, including the steps of: capturing the design rationale in a graphical format, and processing the graphical format to allow the first design rationale to be identified when the at least one design issue is encountered on a second design project.

35. A method for capturing and reusing a design rationale of a first project, the design rationale containing data on at least one design issue, including the steps of: capturing the design rationale in a graphical format; and processing the graphical format to allow the first design rationale to be identified when the at least one design issue is encountered on a second design project.

36. A method according to claim 35 utilising an issue-based information system.

37. A method according to claim 33 wherein the step of capturing the design rationale in graphical format incorporates the step of utilising nodes of a graph editor.

38. A computer programmed to capture and reuse a design rationale of a first project, the design rationale containing data on at least one design issue.

39. A computer programmed to capture design knowledge information, the design knowledge information being generated or acquired during progress of a first design project wherein the information extends beyond project design information includes information evolution of the first design project and causal dependencies including means for: storing the information in a storage means; and input means for inputting information into the storage means by first classifying a design stage and selecting a predefine file with a list of predefined issues to be addressed and presenting a file template to a user to allow the information to be input by the user in a predefined knowledge structure.

40. A computer programmed to capture and reuse a design rationale of a first project, the design rationale containing data on at least one design issue including means for: capturing the design rationale in a graphical format, and processing the graphical format to allow the first design rationale to be identified when the at least one design issue is encountered on a second design project.

41. A computer programmed to capture design knowledge information, wherein the design knowledge information is generated or acquired during progress of a first design project, the information extending beyond product design information and including information on evolution of the first design project and causal dependencies, according to the method described in claim 33.

42. A computer programmed to capture design information, wherein the design information is generated or acquired during progress of a first design project, the information extending beyond product design information and including information on evolution of the first design project and causal dependencies leading from one design to another.

43. A computer programmed to capture design information, the design information being generated or acquired during progress of a first design project wherein the information extends beyond project design information and includes information evolution of the first design project and causal dependencies including means for: storing the information on a storage means; and means for inputting the information into the storage means by first classifying a design stage and selecting a predefined file with a list of predefined issues to be addressed and presenting a file template to a user to allow the information to be input by the user in a predefined knowledge structure.

44. A computer program executable to capture design knowledge information, wherein the design knowledge information is generated or acquired during progress of a first design project, the information extending beyond product design information and including information on evolution of the first design project and causal dependencies, according to the method described in claim 33.

45. A computer program executable to capture and reuse a design rationale of a first project, the design rationale containing data on at least one design issue.

46. A computer program executable to capture design information, wherein the design information is generated or acquired during progress of a first design project, the information extending beyond product design information and including information on evolution of the first design project and causal dependencies leading from one design to another.

47. A data storage medium on which is stored a computer program according to claim 44.

48. A system operable to capture and reuse a design rationale of a first project, the design rationale containing data on at least one design issue according to the method described above.

49. A system operable to capture design knowledge/information, the design knowledge/information being generated or acquired during progress of a first design project wherein the information extends beyond project design information and includes information on evolution of the first design project and causal dependencies, according to the method described above.

50. A system operable to capture design knowledge information, the design knowledge information being generated or acquired during progress of a first design project wherein stored information extends beyond project design information and includes information on evolution of the first design project and causal dependencies, according to the method of claim 33.

51. A system operable to capture and reuse a design rationale of a first project, the design rationale containing data on at least one design issue according to the method described above.

52-54. (canceled)
